(19) United States
(12) Patent Application Publication
(10) Pub. No.: US 2016/0299229 A1
(43) Pub. Date: Oct. 13, 2016

(54) METHOD AND SYSTEM FOR DETECTING OBJECTS

(71) Applicant: Sharper Shape Oy, Espoo (FI)

(72) Inventor: Tero Heinonen, Jarvenpaa (FI)

(21) Appl. No.: 14/682,472

(22) Filed: Apr. 9, 2015

(51) Int. Cl. G01S 17/93; G01S 17/42

(52) U.S. Cl. CPC G01S 17/933; G01S 17/42; G01S 17/936

(57) ABSTRACT

A method of detecting objects is provided. Measurement data is collected from a plurality of different spatial positions. At least one predefined model is matched with the measurement data over the plurality of different spatial positions. Based on the match, at least one object present at the plurality of different spatial positions is detected.

### TECHNICAL FIELD

The present disclosure relates generally to optical remote sensing; and more specifically, to methods of detecting objects. Moreover, the present disclosure relates to systems for detecting objects. Moreover, the present disclosure relates to an apparatus for detecting objects. Furthermore, the present disclosure also concerns computer program products comprising non-transitory machine-readable data storage media having stored thereon program instructions that, when accessed by a processing device, cause the processing device to execute the aforesaid methods.

### BACKGROUND

Light Detection And Ranging (LiDAR) is an optical remote sensing technology that is commonly used to measure distances to one or more targets. A LiDAR equipment includes a light source for illuminating a target region with light, for example, such as ultraviolet, visible, or near infrared light. The light source can be a laser (light amplification by stimulated emission of radiation) source that emits laser pulses. The LiDAR equipment further includes a light detector arrangement for detecting light beams reflected back from the target region. The LiDAR equipment then calculates distances to one or more targets by measuring a time taken by the light beams to return to the LiDAR equipment.

In existing LiDAR technologies, points are generated corresponding to each “echo” received for a transmitted laser pulse. The term “echo” generally refers to a light wave consisting of photons, which may be filtered by wavelength prior to registering in a light detector to filter out wavelengths other than a wavelength of the transmitted laser pulse. Moreover, in the existing LiDAR technologies, an attempt is made to estimate a time between transmitting of the laser pulse and receiving of each echo for the laser pulse. As the speed of light is known for each mediating material, a distance between the LiDAR equipment and a target can be estimated. In this regard, the estimated distance is discretized for each peak in each received echo of the laser pulse as a single distance metric.

The discretization causes problems, as only information that is available at the time of discretization is a particular waveform of a given received echo. Typically, the distance is discretized either for a highest pulse within a timeframe, or for each peak in the received echo that exceeds a certain threshold. When the distance is discretized for the highest pulse, information is lost, as only one target object along a path of the laser pulse can be recorded. This prevents, for example, vegetation monitoring and analysis, where a laser pulse reflects partially from several branches of a tree and partially from the ground or other solid object. On the other hand, when the distance is discretized for each peak exceeding the certain threshold, following problems are encountered in a case of a poor Signal-to-Noise Ratio (SNR):

(i) no peak in the received echo exceeds the threshold, thereby resulting in no discretized measurement detection, namely a false negative; or
(ii) some of noise peaks exceed the threshold, thereby resulting in many false detections, namely false positives.

Moreover, an exact timing, namely an accurate discretization, of a given peak of the received echo is difficult to determine, as a waveform of each echo can vary due to one or more of: (a) the laser source, (b) diffraction in a transmitting matter, which typically is air, (c) multipath reflections, (d) noise, (e) reflective properties of a target object, which may for example cause skewness in the waveform, (f) jitter, (g) walk error as a function of an optical input pulse amplitude, (h) ambient light and other light sources, and (i) interference. Moreover, a light detector can saturate in case of excess exposure, thereby deteriorating the waveform due to clipping of the received echo. Consequently, there is a need for a LiDAR system that is tolerable to (i) timing errors in waveforms, (ii) severe deterioration in waveforms and (iii) poor SNR due to the above mentioned factors.

Furthermore, limiting factors for many practical applications of LiDAR include safety, in particular eye safety, which restricts power of the laser source depending on a frequency used. Moreover, more powerful the laser source is, heavier and physically larger the laser source is. This is due to requirements of the laser source and requirements for cooling and casing of the laser source. Moreover, power and heat dissipation are often limited in integrated devices. For many applications, for example an integration in a mobile handheld device, the aforementioned limiting factors restrict applicable laser emission power. Consequently, there is a need for the LiDAR system to be operative at as less emission power as possible.

A problem with lesser emission power is that the SNR of the received echo is reduced. One conventional method of improving the SNR involves collecting multiple measurements from a same measurement point over time, and integrating the multiple measurements to generate measurement data. This severely limits an applicability of the conventional method in some cases, for example, where a LiDAR equipment is moving, turning, or rotating and/or a target object is moving. This causes limitations on a time duration for which the collected measurements can be integrated. As an example, an aircraft may travel at a speed of 1500 m/s. Assuming a radius of a cone formed by a laser beam to be 1.0 meter at a distance of the aircraft and a maximum extent of the aircraft to be 10.0 meter, a maximum integration time for the collected measurements would be only 6.7 ms. Consequently, there is a need for a LiDAR system that is capable of detecting rapidly moving objects even with reduced SNR.

### SUMMARY

The present disclosure seeks to provide an improved method of detecting objects.

The present disclosure also seeks to provide an improved system for detecting objects.

A further aim of the present disclosure is to at least partially overcome at least some of the problems of the prior art, as discussed above.

In a first aspect, embodiments of the present disclosure provide a method of detecting objects, the method comprising:

collecting measurement data from a plurality of different spatial positions;
matching at least one predefined model with the measurement data over the plurality of different spatial positions; and
detecting at least one object present at the plurality of different spatial positions, based on the matching.

In a second aspect, embodiments of the present disclosure provide an apparatus for detecting objects, the apparatus comprising:

a light source;
a light detector; and
a processor communicably coupled to the light source and the light detector, wherein the processor is configured to:
control the light source and the light detector to collect measurement data from a plurality of different spatial positions;
match at least one predefined model with the measurement data over the plurality of different spatial positions; and
detect at least one object present at the plurality of different spatial positions, based on the match.

In a third aspect, embodiments of the present disclosure provide a system for detecting objects, the system comprising:

at least one measurement device comprising:
a light source;
a light detector; and
a processor communicably coupled to the light source and the light detector, the processor being configured to control the light source and the light detector to collect measurement data from a plurality of different spatial positions; and
   a data processing arrangement communicably coupled to the at least one measurement device, wherein the data processing arrangement is configured to:
collect the measurement data from the at least one measurement device;
match at least one predefined model with the measurement data over the plurality of different spatial positions; and
detect at least one object present at the plurality of different spatial positions, based on the match.

In a fourth aspect, embodiments of the present disclosure provide a computer program product comprising a non-transitory machine-readable data storage medium having stored thereon program instructions that, when accessed by a processing device, cause the processing device to:

collect measurement data from a plurality of different spatial positions;
match at least one predefined model with the measurement data over the plurality of different spatial positions; and
detect at least one object present at the plurality of different spatial positions, based on the match.

Embodiments of the present disclosure substantially eliminate or at least partially address the aforementioned problems in the prior art, and enable detection of objects for measurements comprising a substantial amount of noise and signal distortion.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is an illustration of steps of a method of detecting objects, in accordance with an embodiment of the present disclosure;

FIG. 2 is a schematic illustration of an example environment, wherein a system for detecting objects is implemented pursuant to an embodiment of the present disclosure;

FIG. 3 is a schematic illustration of another example environment, wherein a system for detecting objects is implemented pursuant to an embodiment of the present disclosure;

FIGS. 4A and 4B collectively are schematic illustrations of various components of an airborne measurement device, in accordance with an embodiment of the present disclosure;

FIG. 5 is a schematic illustration of how a LiDAR sensor works;

FIG. 6 is a schematic illustration of an example measurement scenario where a measurement device is moving in a proximity of an object;

FIG. 7 is a schematic illustration of another example measurement scenario where a measurement device is far away from an object;

FIG. 8 is a schematic illustration of a first example of how model matching can be used for object detection, in accordance with an embodiment of the present disclosure; and

FIG. 9 is a schematic illustration of a second example of how model matching can be used for object detection, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

### GLOSSARY

Brief definitions of terms used throughout the present disclosure are given below.

The term “model matching” generally refers to a measure of how well a particular model matches certain measurement data. Model matching can be performed using, for example, cross-correlation or template matching.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the present disclosure provided herein, one of ordinary skill in the art will appreciate a variety of ways in which connection or coupling exists in accordance with the aforementioned definition.

The phrases “in an embodiment”, “in accordance with an embodiment” and the like generally mean the particular feature, structure, or characteristic following the phrase is included in at least one embodiment of the present disclosure, and may be included in more than one embodiment of the present disclosure Importantly, such phrases do not necessarily refer to the same embodiment.

If the specification states a component or feature “may”, “can”, “could”, or “might” be included or have a characteristic, that particular component or feature is not required to be included or have the characteristic.

### EMBODIMENTS OF THE PRESENT DISCLOSURE

In a first aspect, embodiments of the present disclosure provide a method of detecting objects, the method comprising:

collecting measurement data from a plurality of different spatial positions;
matching at least one predefined model with the measurement data over the plurality of different spatial positions; and
detecting at least one object present at the plurality of different spatial positions, based on the matching.

Herein, the term “plurality of different spatial positions” generally refers to different spatial positions from where the measurement data has been collected. As an example, the aforementioned spatial positions correspond to surfaces from which light beams emitted by a Light Detection And Ranging (LiDAR) sensor are reflected back to the LiDAR sensor.

It is to be noted that the measurement data is collected and recorded as a function of time. One or both of a measurement device collecting the measurement data and an object being detected may be moving. Therefore, the measurement data is normalized spatially, for example, into absolute coordinates. Moreover, optionally, the measurement data can be preprocessed before the matching, for example, using spatiotemporal filtering.

In an example where the measurement data is collected by a moving measurement device, for example, such as an airborne device, a vehicle, a robot and the like, the aforementioned spatial positions can be determined from spatial positions and orientations of the moving device, as will be described later. The spatial positions and the orientations of the moving device are typically known from a Global Navigation Satellite Systems (GNSS) unit and an Inertial Measurement Unit (IMU) of the moving device.

Moreover, it is to be noted that the measurement data can be collected in any suitable form. Pursuant to embodiments of the present disclosure, the aforementioned method can be applied to various forms of LiDAR, for example, such as scanning LiDAR, LiDAR arrays, focal plane LiDAR, and flash LiDAR. As an example, the measurement data can be captured “frame by frame”. As another example, the measurement data can be scanned “line by line”, for example, using a scanning LiDAR arrangement.

Optionally, the aforementioned method can be implemented for real-time modelling of surroundings based on LiDAR measurements. For illustration purposes only, the aforementioned has been illustrated with respect to LiDAR applications. It is to be noted here that the aforementioned method can be applied to other forms of optical or radiometric distance measurement techniques, for example, such as Synthetic-Aperture Radar (SAR) and Infra-Red Thermography (IRT).

Pursuant to embodiments of the present disclosure, the aforementioned method can be used for various potentially valuable applications, for example, such as long range LiDAR sensors in smartphones, lightweight LiDAR sensors in unmanned aerial vehicles and robotics, and small-scale LiDAR sensors for covert security.

Furthermore, the aforementioned method can be used in various applications, for example, such as geomatics, geology, seismology, forestry, remote sensing, surveys, inspections, security and surveillance, and collision detection and avoidance. Herein, the term “geomatics” refers to tools and techniques used in land surveying, remote sensing, cartography, Geographic Information Systems (GIS), Global Navigation Satellite Systems (GNSS), photogrammetry, geography and related forms of earth mapping. Objects detectable by the aforementioned method include physical objects, such as ground, buildings, vegetation, highways, pipelines, corridor lines, vehicles, people, and so on. The aforementioned method can also be used to detect smaller scale objects, for example, such as body part movements of people, skeleton tracking, common household objects, facial expressions, machinery, industrial equipment, pipelines, and cabling.

Optionally, when collecting the measurement data, a narrow laser beam is employed for mapping physical objects and their features with a high resolution. This enables accurate reconstruction of a three-dimensional (3D) model of a detected object. As an example, employing the narrow laser beam enables mapping a single branch of a tree with a high resolution.

Optionally, when collecting the measurement data, a broader and more divergent laser beam is employed for detecting a presence and a distance of an object with a high confidence. This enables reliable detection of a presence of objects in surroundings. As an example, employing the broader laser beam enables detection of a moving object, such as a vehicle or an airplane, approaching from a distance.

According to an embodiment, the at least one predefined model is selected from a group consisting of a planar surface, a polygon, a line, a curve, a catenary, a triangle, a rectangle, and a spline surface. The term “model” generally refers to a shape of interest. Optionally, a given model corresponds to a particular pose and/or a particular size of a particular shape of interest.

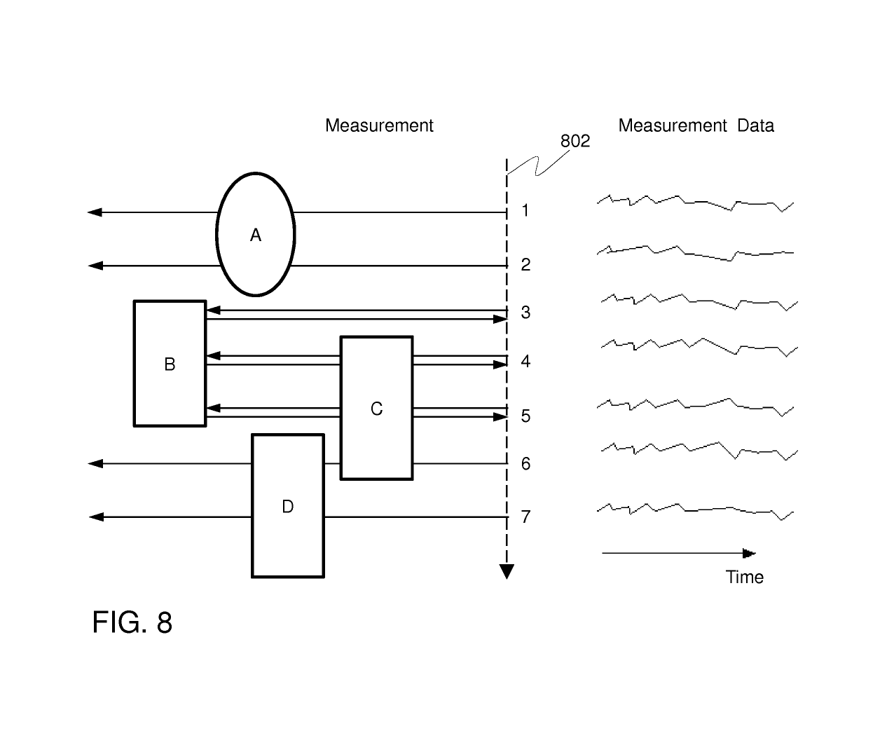

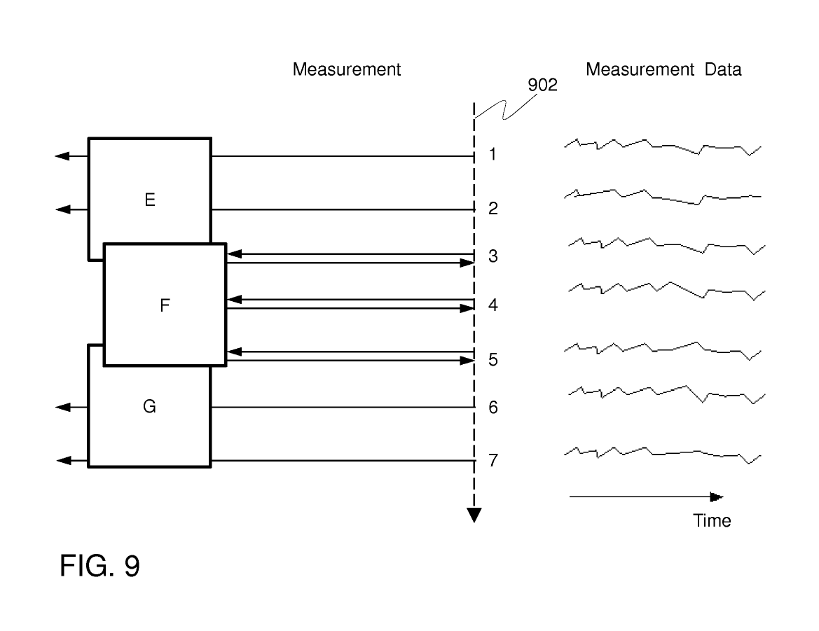

According to an embodiment, the measurement data comprises a substantial amount of noise. In this regard, optionally, the matching comprises combining the measurement data for pluralities of spatial positions. Details of the model matching have been provided in conjunction with FIGS. 8 and 9.

Optionally, the detecting comprises detecting an object in a given plurality of spatial positions when a combination of the measurement data for the given plurality of spatial positions substantially matches at least one model defined for the object.

For illustration purposes only, there will now be considered an example of how the aforementioned method can be implemented pursuant to embodiments of the present disclosure.

Step 0: A set of predefined models is defined. Beneficially, the set of predefined models corresponds to a specific application of the aforementioned method in a given measured environment. Accordingly, the set of predefined models is defined based on a priori information of the specific application of the aforementioned method. As an example, the a priori information may be indicative of whether a measurement device and/or an object being detected is moving. As another example, the a priori information may be indicative of certain objects that are required to be detected. As another example, the a priori information may include the probability distribution recorded earlier for at least one model. As another example, the a priori information may include the probability distribution recorded earlier of at least one model modified by a temporal factor such as predicting the movement of the object. The prediction of the movement of the object can be done for example using Kalman Filter, Extended Kalman Filter, or Particle Filter.
Step 1: A first predefined model is selected from the set of predefined models. As mentioned earlier, the first predefined model corresponds to a first shape of interest. Optionally, the first predefined model also corresponds to a pose and/or a size of the first shape.
Step 2: The first predefined model is matched with the measurement data over the plurality of different spatial positions. In other words, the measurement data is combined for pluralities of spatial positions to find if there is a match between the first predefined model and the measurement data for at least one of the pluralities of spatial positions.
Step 3: A next predefined model is selected from the set of predefined models, and the step 2 is repeated for the next predefined model. The step 3 is performed iteratively till each predefined model of the set of predefined models is matched with the measurement data. In other words, the step 3 is iteratively performed for all possible poses and/or sizes of each shape of interest.
Step 4: The model matching performed for all of the predefined models are compared to determine a probability of a particular predefined model being present in the measurement data.

As an example, a probability that a particular predefined model is present in the measurement data can be calculated using Bayes' theorem. In this regard, the probability can be calculated by integrating over all predefined models, namely shapes and their respective poses and spatial positions, with respect to the measurement data as follows:

$$P ( M \vert D ) = \frac{P ( D \vert M ) P ( M )}{P ( D )} ,$$

wherein
‘M’ represents a particular model,
‘D’ represents the measurement data,
‘P(M|D)’ represents a probability of the particular model, given the measurement data, which is indicative of a probability of a presence of the particular model,
‘P(D|M)’ represents a probability of certain measurement data, given the particular model,
‘P(M)’ represents a probability of the particular model, and
‘P(D)’ represents a probability of data sampling.

As an example, if a uniform data sampling is used during collection of the measurement data, the probability of data sampling ‘P(D)’ is constant, while if certain locations are sampled more than others, the probability of data sampling ‘P(D)’ has a corresponding value.

Hereinabove, the probability of the particular model ‘P(M)’ corresponds to known characteristics of the particular model. As an example, it is unlikely that a car would fly. As another example, it is unlikely that an airplane would jump 10 km in a second from where it was previously detected. This enables the model matching to rule out or give very low probability to certain models that would not be applicable for the measurement data being processed.

In this manner, a probability distribution of probabilities of all the predefined models is determined at the aforementioned step 4. Subsequently, the probability distribution is processed for object detection based on the specific application of the method. Optionally, in this regard, the object detection is performed by at least one of:

(i) selecting at least one model with a highest probability to represent a discrete state of the given measured environment,
(ii) determining a location of the at least one model within the given measured environment by calculating a probability-weighted average of possible locations of the at least one model, and/or
(iii) determining a location of the at least one object within the given measured environment by calculating a probability-weighted average of possible locations of the at least one model corresponding to the said object, and/or
(iii) determining a probable location of the at least one object by estimating the location and a size of a smallest sphere that encircles the cumulative probability of models corresponding to the said object with at least of a threshold cumulative probability.

Furthermore, optionally, the probability distribution consisting of the probability of at least one model is recorded for future reference. As an example, a previous recordation of the probability distribution can be used to rule out anomalies when measurement data is collected and processed for the same environment in future.

An example of how probabilities can be used for object detection has been provided in conjunction with FIG. 9 as well as below.

For illustration purposes only, there will now be considered an example situation where certain objects are required to be identified in a given environment. In the example, let us consider that the aforementioned method is implemented for monitoring powerlines in uninhabited forests via an airborne device. In such a case, examples of certain shapes of interest may include:

(i) certain species of trees, for example, such as spruce, birch and pine,
(ii) powerline conductors, which are typically seen as catenaries, and
(iii) certain types of poles supporting the conductors.

Accordingly, a set of predefined models takes into consideration several variants of a particular shape of interest, for example, with respect to different poses and/or different sizes of that particular shape. As an example, spruce trees can be distinguished by their whorled branches and conical form. As another example, the poles can be distinguished by their smooth structures. As another example, the conductors can be distinguished by their catenary curve shape.

Accordingly, the method is implemented to detect a presence of at least one of the predefined models in the given environment. When monitoring the powerlines, a purpose of implementing the method could be to identify which trees in a proximity of the powerlines are susceptible to fall on the powerlines during a next storm.

Moreover, optionally, the method can include guiding the airborne device to follow a length of the powerlines. Such guidance can be given once the powerline conductors have been detected using the method, as described earlier.

It will be appreciated that depending on a specific application of the method, only a limited number of models of different objects are required to be matched with measurement data.

Moreover, in this example, a single datapoint at a given spatial position is required to be scanned only once. As a result, model matching is performed when a sufficient amount of new measurement data is collected.

Moreover, a priori information, for example, such as a previous recordation can be used to filter out anomalies. As an example, a full-grown tree cannot exist at a given spatial position, if a previous recent recordation indicates absence of any vegetation at the given spatial position.

Moreover, spatial positions of the models can be restricted using a priori known flight properties of the airborne device. As an example, the airborne device can be configured to fly at an altitude of 100 m, while a LiDAR sensor employed in the airborne device can be configured to capture measurements with an angle of 45 degrees.

Furthermore, as the LiDAR sensor may produce a data sample, for example, every few centimeters, the method can be implemented to detect a perimeter of a tree. Optionally, the method then includes using a simple mechanism, for example, such as distance variance inside the perimeter as a parameter for the model matching.

It will be appreciated that the aforementioned method is suitable for detecting complex shapes. As an example, the method can be implemented to detect a complex shape by using a generalization of such a shape, for example, such as a mesh of triangles or polygons.

It will be appreciated that the aforementioned method is suitable for detecting complex shapes of arbitrary form such as at least one of mathemetical curves, planes, or three dimensional volumes which may represent (i) the surface of the object, (ii) the internal structure of a non-solid object, (iii) both the surface of the object and the internal structure of a non-solid object.

As an example, the method can be implemented to detect a complex shape by using a generalization of such a shape, for example, such as a mesh of triangles or polygons.

For illustration purposes only, there will now be considered another example situation where the aforementioned method is implemented for vehicle navigation and safety. In this example, the method can be implemented for detecting moving objects that may collide with a moving vehicle. In such a case, examples of certain shapes of interest may include other vehicles, pedestrians and animals.

In this example, measurement data is collected repeatedly and continuously, and a sampling frequency of a LiDAR sensor employed is considerably higher with respect to a speed of the moving vehicle. Moreover, in this example, a single datapoint at a given spatial position is required to be scanned repeatedly. As a result, model matching is performed repeatedly, and a probability distribution is recorded and updated accordingly for future references.

Optionally, in this example, the method includes automatically braking the moving vehicle if an object that is about to collide is detected.

It is to be noted here that the aforementioned method is not limited to implementation in airborne devices or self-driven vehicles. As an example, the aforementioned method can be implemented for various potentially valuable applications, as mentioned earlier.

In a second aspect, embodiments of the present disclosure provide an apparatus for detecting objects, the apparatus comprising:

a light source;
a light detector; and
a processor communicably coupled to the light source and the light detector, wherein the processor is configured to:
control the light source and the light detector to collect measurement data from a plurality of different spatial positions;
match at least one predefined model with the measurement data over the plurality of different spatial positions; and
detect at least one object present at the plurality of different spatial positions, based on the match.

According to an embodiment, the measurement data comprises a substantial amount of noise. In this regard, optionally, the processor is configured to combine the measurement data for pluralities of spatial positions during the model matching. Optionally, the processor is configured to detect an object in a given plurality of spatial positions when a combination of the measurement data for the given plurality of spatial positions substantially matches at least one model defined for the object.

According to an embodiment, the at least one predefined model is selected from a group consisting of a planar surface, a polygon, a line, a curve, a catenary, a triangle, a rectangle, and a spline surface. As described earlier, a given model corresponds to a particular shape of interest, and optionally, to a particular pose and/or size of that particular shape.

According to an embodiment, the apparatus is implemented by way of an airborne measurement device. Optionally, the airborne measurement device is selected from a group consisting of a helicopter, a multi-copter, a fixed-wing aircraft and an unmanned aerial vehicle.

According to an embodiment, the apparatus is implemented as a part of a vehicle navigation and safety system. As an example, such a vehicle navigation and safety system can be implemented within self-driven vehicles, for example, for facilitating collision avoidance, adjustable cruise control, lane assistance, and parking assistance.

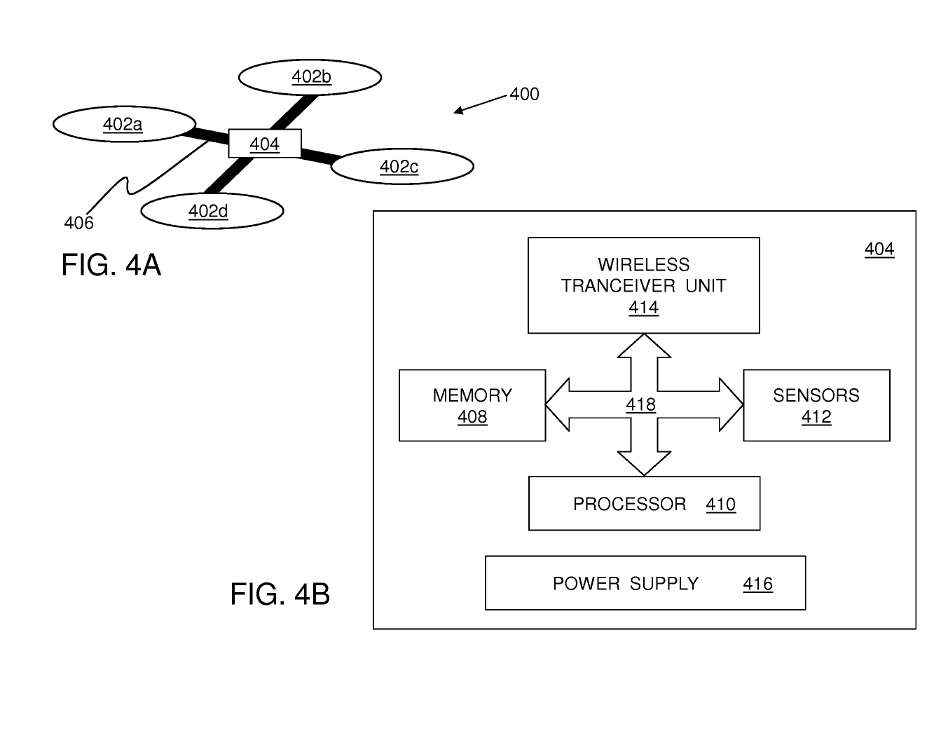

Furthermore, an example airborne measurement device has been illustrated in conjunction with FIGS. 4A and 4B as explained in more detail below. In accordance with an embodiment of the present disclosure, an airborne measurement device includes at least one propeller, wherein each propeller includes its associated motor unit for driving that propeller. The airborne measurement device also includes a main unit that is attached to the at least one propeller by at least one arm. It is to be noted here that the airborne measurement device could alternatively be implemented by way of miniature helicopters, miniature multi-copters, miniature fixed-wing aircrafts, miniature harriers, or other unmanned aerial vehicles.

The main unit includes, but is not limited to, a data memory, a computing hardware such as a processor, a configuration of sensors, a wireless transceiver unit, a power source, and a system bus that operatively couples various sub-components of the main unit including the data memory, the processor, the configuration of sensors and the wireless transceiver unit.

The power source supplies electrical power to various components of the airborne measurement device, namely, the at least one propeller and the various sub-components of the main unit.

Optionally, the power source includes a rechargeable battery, for example, such as a Lithium-ion battery. The battery may be recharged or replaced, when the airborne measurement device lands, for example, on a landing platform of a ground station.

The data memory optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

Moreover, the configuration of sensors includes at least one of: a LiDAR sensor, an inertial measurement unit (IMU), a global navigation satellite system (GNSS) unit, an altitude meter, a magnetometer, an accelerometer, and/or a gyroscopic sensor.

A LiDAR sensor included in the configuration of sensors is operable to scan surroundings of the airborne measurement device. The LiDAR sensor includes a light source and a light detector. Optionally, the light source includes at least one mechanical mirror, a matrix of laser sources and associated optics. Optionally, the light detector includes optics and a matrix of Single Photon Avalanche Diodes (SPAD's).

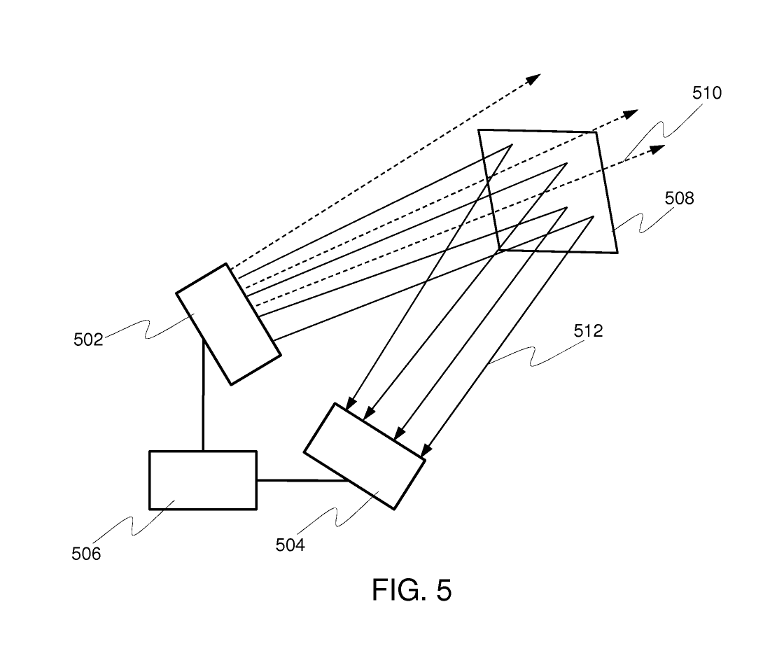

The light source is operable to emit light beams, while the light detector is operable to detect light beams reflected back from surfaces in the surroundings of the airborne measurement device. Details of how a LiDAR sensor works have been provided in conjunction with FIG. 5.

The processor is configured to control the LiDAR sensor, namely the light source and the light detector, to collect measurement data from a plurality of different spatial positions.

Moreover, the processor is configured to measure a time that each light beam takes to return to the LiDAR sensor. The processor is configured to determine, from the measured time, a distance between the airborne measurement device and a surface from which that light beam reflected back to the LiDAR sensor. As an example, the distance can be calculated as follows:

d=½c×t

where
‘d’ represents the distance between the airborne measurement device and the surface,
‘c’ represents a speed of light, and
‘t’ represents the time taken by that light beam to return to the LiDAR sensor.

Optionally, the measurement data and corresponding distances are initially recorded as a function of time and an aerial route traversed by the airborne measurement device. In this regard, optionally, a GNSS unit included in the configuration of sensors is employed to determine normalized spatial position, for example absolute spatial positions of the airborne measurement device upon a surface of the Earth when collecting the measurement data. Additionally, optionally, an IMU included in the configuration of sensors is employed to determine orientations of the airborne measurement device when collecting the measurement data. For the sake of clarity, the normalized spatial positions of the airborne measurement device are hereinafter referred to as “device positions”, while the orientations of the airborne measurement device are hereinafter referred to as “device orientations”. For the sake of clarity, the normalized spatial positions may be for example a coordinate system bound to earth such as WGS-84 or any normalized coordinate system based on the locality of the measurements such as Gauss-Krüger coordinate system or arbitrarily selected Euclidian coordinate system.

Knowledge of the device positions, the device orientations and distances between the airborne measurement device and surfaces from which emitted light beams reflected back to the LiDAR sensor enables the processor to determine the plurality of different spatial positions from where the measurement data are collected.

Furthermore, the processor is configured to use the wireless transceiver unit to communicate, for example, with a ground station. As an example, the processor can be configured to receive control instructions from the ground station, for example, including instructions and/or information pertaining to a planned aerial route to be traversed by the airborne measurement device.

Optionally, the processor is configured to use the wireless transceiver unit to send the measurement data to the ground station. Alternatively, optionally, the measurement data is stored in the data memory of the main unit, and is downloaded to a processing device of the ground station when the airborne measurement device lands on the ground station.

According to an embodiment, the processor is configured to at least partially analyse the measurement data to detect at least one object present at the plurality of different spatial positions, namely to detect a shape, a pose and/or a size of the at least one object. For this purpose, the processor is configured to match at least one predefined model with the measurement data over the plurality of different spatial positions.

Moreover, optionally, the processor is configured to generate at least one map indicative of a shape, a pose and/or a size of the at least one object present at the plurality of different spatial positions.

In a third aspect, embodiments of the present disclosure provide a system for detecting objects, the system comprising:

at least one measurement device comprising:
a light source;
a light detector; and
a processor communicably coupled to the light source and the light detector, the processor being configured to control the light source and the light detector to collect measurement data from a plurality of different spatial positions; and
   a data processing arrangement communicably coupled to the at least one measurement device, wherein the data processing arrangement is configured to:
collect the measurement data from the at least one measurement device;
match at least one predefined model with the measurement data over the plurality of different spatial positions; and
detect at least one object present at the plurality of different spatial positions, based on the match.

According to an embodiment, the measurement data comprises a substantial amount of noise. In this regard, optionally, the data processing arrangement is configured to combine the measurement data for pluralities of spatial positions during the model matching. Optionally, the data processing arrangement is configured to combine the measurement data for pluralities of spatial and temporal positions during the model matching. Optionally, the data processing arrangement is configured to detect an object in a given plurality of spatial positions when a combination of the measurement data for the given plurality of spatial positions substantially matches at least one model defined for the object.

According to an embodiment, the at least one predefined model is selected from a group consisting of a planar surface, a polygon, a line, a curve, a catenary, a triangle, a rectangle, and a spline surface.

According to an embodiment, the at least one measurement device is implemented by way of an airborne measurement device. Optionally, the airborne measurement device is selected from a group consisting of a helicopter, a multi-copter, a fixed-wing aircraft, a harrier and an unmanned aerial vehicle.

According to an embodiment, the system is implemented as a part of a vehicle navigation and safety system. As an example, such a vehicle navigation and safety system can be implemented within self-driven vehicles, for example, for facilitating collision avoidance, adjustable cruise control, lane assistance, and parking assistance.

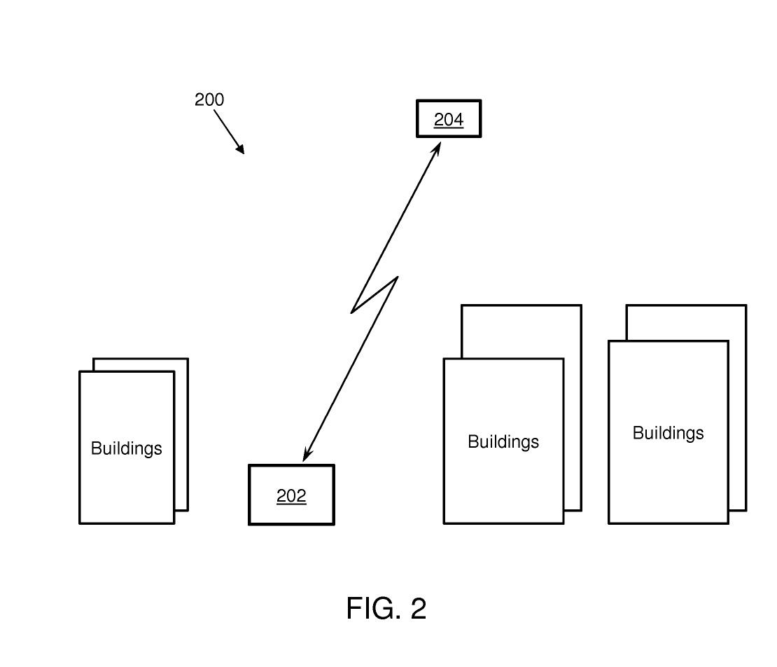

For illustration purposes only, there will now be considered an example environment where the aforementioned system is implemented pursuant to embodiments of the present disclosure. One such example environment has been illustrated in conjunction with FIG. 2 as explained in more detail below.

In the example environment, a ground station is installed at a certain geographical position that is surrounded by a city infrastructure, such as buildings. It will be appreciated that the ground station can be installed in various ways. In an example, the ground station can be installed on a vehicle, such as a car, a truck, an all-terrain vehicle, a snow mobile and the like. In another example, the ground station can be installed on the ground surface of the Earth, a building, a bridge or any suitable infrastructure.

In the example environment, at least one airborne measurement device is configured to fly along a planned aerial route in the surroundings of the ground station.

The at least one airborne measurement device includes, inter alia, a computing hardware such as a processor and a configuration of sensors. Moreover, the configuration of sensors includes at least one of: a LiDAR sensor, an IMU, a GNSS unit, an altitude meter, a magnetometer, an accelerometer, and/or a gyroscopic sensor.

A LiDAR sensor, included in the configuration of sensors, includes a light source and a light detector. The light source is operable to emit light beams, while the light detector is operable to detect light beams reflected back from surfaces in the surroundings of the at least one airborne measurement device.

The processor is configured to control the LiDAR sensor, namely the light source and the light detector, to collect measurement data from a plurality of different spatial positions.

Moreover, the processor is configured to measure a time that each light beam takes to return to the LiDAR sensor, and determine, from the measured time, a distance between the at least one airborne measurement device and a surface from which that light beam reflected back to the LiDAR sensor.

Optionally, the measurement data and corresponding distances are initially recorded as a function of time and an aerial route traversed by the at least one airborne measurement device. In this regard, optionally, a GNSS unit included in the configuration of sensors is employed to determine absolute spatial positions of the at least one airborne measurement device upon a surface of the Earth when collecting the measurement data. Additionally, optionally, an IMU included in the configuration of sensors is employed to determine orientations of the at least one airborne measurement device when collecting the measurement data. For the sake of clarity, the absolute spatial positions of the at least one airborne measurement device are hereinafter referred to as “device positions”, while the orientations of the at least one airborne measurement device are hereinafter referred to as “device orientations”.

Knowledge of the device positions, the device orientations and distances between the at least one airborne measurement device and surfaces from which emitted light beams reflected back to the LiDAR sensor enables the processor to determine the plurality of different spatial positions from where the measurement data are collected.

Furthermore, the ground station includes a data processing arrangement that is configured to collect the measurement data from the at least one airborne measurement device. The data processing arrangement is configured to match at least one predefined model with the measurement data over the plurality of different spatial positions, and detect at least one object present at the plurality of different spatial positions, based on the match.

Moreover, optionally, the data processing arrangement is configured to generate at least one map indicative of a shape, a pose and/or a size of the at least one object present at the plurality of different spatial positions.

In an alternative implementation, the ground station is configured to deliver the measurement data to a data processing arrangement that is remote to the ground station. In such a case, the data processing arrangement is configured to perform the model matching and the detection.

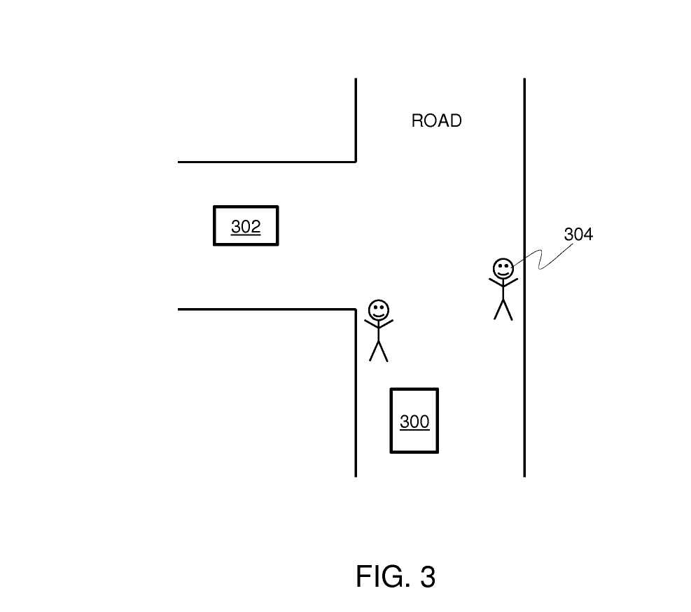

For illustration purposes only, there will next be considered another example environment where the aforementioned system is implemented pursuant to embodiments of the present disclosure. One such example environment has been illustrated in conjunction with FIG. 3 as explained in more detail below.

In the example environment, the aforementioned system pursuant to embodiments of the present disclosure is implemented as a part of a vehicle navigation and safety system of a self-driven vehicle. The system can be implemented for detecting moving objects that may collide with the vehicle moving on a road. In such a case, examples of certain shapes of interest may include other vehicles, pedestrians and animals.

Moreover, the system can be configured to automatically brake the moving vehicle if an object that is about to collide is detected.

In a fourth aspect, embodiments of the present disclosure provide a computer program product comprising a non-transitory machine-readable data storage medium having stored thereon program instructions that, when accessed by a processing device, cause the processing device to:
collect measurement data from a plurality of different spatial positions;
match at least one predefined model with the measurement data over the plurality of different spatial positions; and
detect at least one object present at the plurality of different spatial positions, based on the match.

### DETAILED DESCRIPTION OF DRAWINGS

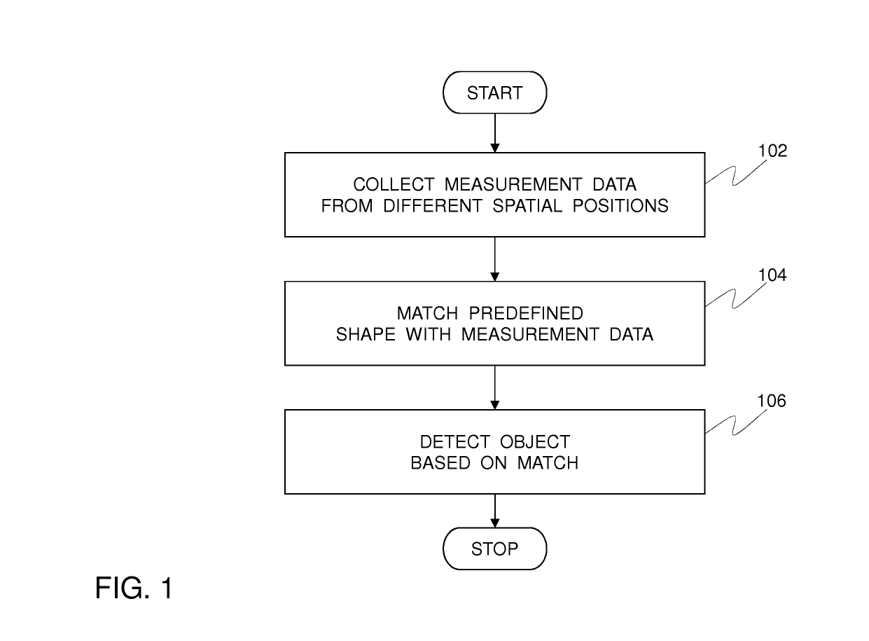

Referring now to the drawings, particularly by their reference numbers, FIG. 1 is an illustration of steps of a method of detecting objects, in accordance with an embodiment of the present disclosure. The method is depicted as a collection of steps in a logical flow diagram, which represents a sequence of steps that can be implemented in hardware, software, or a combination thereof.

At a step 102, measurement data is collected from a plurality of different spatial positions.

At a step 104, at least one predefined model is matched with the measurement data over the plurality of different spatial positions.

Subsequently, at a step 106, at least one object present at the plurality of different spatial positions is detected, based on the model matching performed at the step 104.

Optionally, the step 104 is iteratively performed for a plurality of predefined models, namely a plurality of shapes of interest and their possible poses and/or sizes. In this regard, the at least one object is detected at the step 106 based on a comparison of the model matching performed at the step 104 for the plurality of predefined models.

Optionally, in accordance with the step 104, a probability of presence of each of the plurality of predefined models is determined from the model matching performed at the step 104 for the plurality of predefined models.

Optionally, in accordance with the step 106, a probability distribution of probabilities for the plurality of predefined models is processed for object detection, as described earlier. Optionally, in this regard, the object detection is performed by at least one of:

(i)
selecting at least one model with a highest probability to represent a discrete state of the given measured environment,
(ii) determining a location of the at least one model within the given measured environment by calculating a probability-weighted average of possible locations of the at least one model, and/or
(iii) determining a location of the at least one object within the given measured environment by calculating a probability-weighted average of possible locations of the at least one model corresponding to the said object, and/or
(iii) determining a probable location of the at least one object by estimating the location and a size of a smallest sphere that encircles the cumulative probability of models corresponding to the said object with at least of a threshold probability.

The steps 102 to 106 are only illustrative and other alternatives can also be provided where one or more steps are added, one or more steps are removed, or one or more steps are provided in a different sequence without departing from the scope of the claims herein.

FIG. 2 is a schematic illustration of an example environment, wherein a system 200 for detecting objects is implemented pursuant to an embodiment of the present disclosure. The system 200 includes a ground station 202 and at least one airborne measurement device, depicted as an airborne measurement device 204 in FIG. 2.

With reference to FIG. 2, the ground station 202 is installed at a geographical position that is surrounded by a city infrastructure, such as buildings.

The airborne measurement device 204 is configured to fly in the surroundings of or away from the ground station 202. The airborne measurement device 204 is configured to communicate with the ground station 202 wirelessly.

FIG. 2 is merely an example, which should not unduly limit the scope of the present disclosure. It is to be understood that the illustration of the system 200 is provided as an example and is not limited to a specific number and/or arrangement of ground stations and airborne measurement devices. A person skilled in the art will recognize many variations, alternatives, and modifications of embodiments of the present disclosure. As an example, the system 200 can be alternatively implemented with more than one airborne measurement devices.

FIG. 3 is a schematic illustration of another example environment, wherein a system 300 for detecting objects is implemented pursuant to an embodiment of the present disclosure. With reference to FIG. 3, the system 300 is implemented as a part of a self-driven vehicle that is moving on a road.

Pursuant to embodiments of the present disclosure, the system 300 is operable to detect other vehicles, depicted as a vehicle 302, and pedestrians 304 moving on the road. As an example, the system 300 can be used to facilitate collision avoidance, lane assistance, parking assistance, and so forth.

FIG. 3 is merely an example, which should not unduly limit the scope of the present disclosure. A person skilled in the art will recognize many variations, alternatives, and modifications of embodiments of the present disclosure.

FIGS. 4A and 4B collectively are schematic illustrations of various components of an airborne measurement device 400, in accordance with an embodiment of the present disclosure. The airborne measurement device 400 includes at least one propeller, depicted as a propeller 402a, a propeller 402b, a propeller 402c and a propeller 402d in FIG. 4A (hereinafter collectively referred to as propellers 402).

The airborne measurement device 400 also includes a main unit 404 that is attached to the propellers 402 by arms 406.

With reference to FIG. 4B, the main unit 404 includes, but is not limited to, a data memory 408, a computing hardware such as a processor 410, a configuration of sensors 412, a wireless transceiver unit 414, a power supply 416 and a system bus 418 that operatively couples various components including the data memory 408, the processor 410, the configuration of sensors 412 and the wireless transceiver unit 414.

FIGS. 4A and 4B are merely examples, which should not unduly limit the scope of the claims herein. It is to be understood that the specific designation for the airborne measurement device 400 is provided as an example and is not to be construed as limiting the airborne measurement device 400 to specific numbers, types, or arrangements of modules and/or components of the airborne measurement device 400. A person skilled in the art will recognize many variations, alternatives, and modifications of embodiments of the present disclosure. It is to be noted here that the airborne measurement device 400 could be implemented by way of miniature helicopters, miniature multi-copters, miniature fixed-wing aircrafts, miniature harriers, or other unmanned aerial vehicles.

FIG. 5 is a schematic illustration of how a LiDAR sensor works. With reference to FIG. 5, the LiDAR sensor includes a light source 502 and a light detector 504. The light source 502 and the light detector 504 are communicably coupled to a processor 506.

In FIG. 5, there is also shown an object 508 at a certain distance from the LiDAR sensor.

The processor 506 is configured to control the light source 502 and the light detector 504 to collect measurement data. In this regard, the light source 502 emits light beams, depicted as light beams 510 in FIG. 5. The light detector 504 detects light beams that reflect back from objects and/or surfaces, for example, such as the light beams 512 that reflect back from the object 508.

Detection of the light beams 512 enables the processor 506 to collect the measurement data.

With reference to FIG. 5, some light beams 510 do not reflect back to the LiDAR sensor and, therefore, do not result in any measurement.

FIG. 5 is merely an example, which should not unduly limit the scope of the claims herein. A person skilled in the art will recognize many variations, alternatives, and modifications of embodiments of the present disclosure.

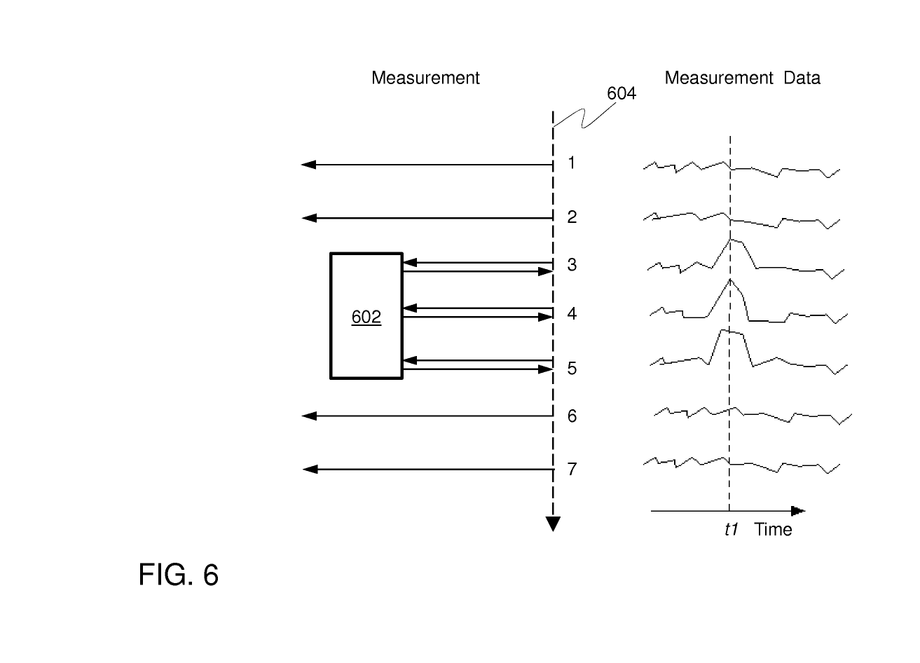

FIG. 6 is a schematic illustration of an example measurement scenario where a measurement device is moving in a proximity of an object 602.

In FIG. 6, there is shown a route 604 that the measurement device traverses during collection of measurement data.

With reference to FIG. 6, the measurement data is collected at seven different measurement points on the route 604. These measurement points have been marked 1, 2, 3, 4, 5, 6 and 7 in FIG. 6.

At each measurement point, the measurement data is collected by emitting light beams from a light source and detecting possible reflections of the light beams at a light detector. A time difference ‘t1’ between the emission of the light beams and the detection of their reflections is used to calculate a distance between the measurement device and the object 602.

With reference to FIG. 6, light beams emitted at the measurement points 1, 2, 6 and 7 do not hit any object and, therefore, do not produce any reflections. As a result, the light detector measures only noise.

On the other hand, light beams emitted at the measurement points 3, 4 and 5 hit the object 602 and reflect back to the light detector. As a result, the light detector detects a reflection peak at the time ‘t1’ from a time of emission of a respective light beam.

In the illustrated example scenario, a Signal-to-Noise Ratio (SNR) is high. Thus, it is easy to detect the object 602, namely a shape, a pose and a size of the object 602, from the measurement data.

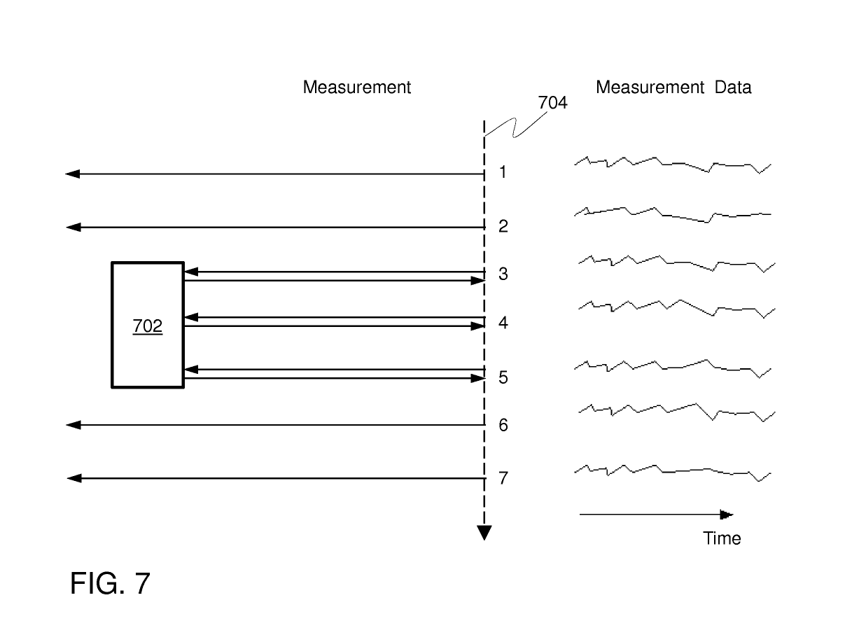

FIG. 7 is a schematic illustration of another example measurement scenario where a measurement device is far away from an object 702, such that measurement data collected by the measurement device has a poor SNR.

In FIG. 7, there is shown a route 704 that the measurement device traverses during collection of measurement data.

With reference to FIG. 7, the measurement data is collected at seven different measurement points on the route 704. These measurement points have been marked 1, 2, 3, 4, 5, 6 and 7 in FIG. 7.

The measurement device is so far away from the object 702 that the measurement data collected for each of the seven measurement points includes a substantial amount of noise. In other words, the SNR of the measurement data is so low that it is not possible to detect the object 702 directly from the measurement data.

The aforementioned method can thus be applied in the illustrated example scenario to enable detection of the object 702, for example, as will be described in conjunction with FIGS. 8 and 9.

FIGS. 6 and 7 are merely examples, which should not unduly limit the scope of the claims herein. It is to be noted here that a number of measurement points at which measurement data can be collected is not limited to any specific number. A person skilled in the art will recognize many variations, alternatives, and modifications of embodiments of the present disclosure.

It is to be noted that a low SNR can be observed in yet another measurement scenario where an emission power of a light source employed is very low. Moreover, a low SNR can be observed in still another measurement scenario where a reflectivity of an object being detected is very low. Thus, the aforementioned method can be applied in such measurement scenarios to enable detection of objects, for example, as will be described in conjunction with FIGS. 8 and 9.

FIG. 8 is a schematic illustration of a first example of how model matching can be used for object detection, in accordance with an embodiment of the present disclosure.

In FIG. 8, there is shown a route 802 that a measurement device traverses during collection of measurement data.

In the illustrated example, the measurement data is collected at seven different measurement points on the route 802. These measurement points have been marked 1, 2, 3, 4, 5, 6 and 7 in FIG. 8.

A first predefined model ‘A’ is assumed to be present at two spatial positions corresponding to the measurement points 1 and 2, as shown in FIG. 8. In this regard, the measurement data corresponding to the measurement points 1 and 2 are combined, and it is checked whether or not a combination of the measurement data corresponding to the measurement points 1 and 2 substantially matches the first predefined model ‘A’. In the example herein, let us consider that the aforesaid combination does not substantially match the first predefined model ‘A’. Thus, it can be concluded that the assumption of the first predefined model ‘A’ is has very low probability. In other words, object having the first predefined model ‘A’ is very unlikely present at the aforesaid spatial positions.

A second predefined model ‘B’ is assumed to be present at three spatial positions corresponding to the measurement points 3, 4 and 5, as shown in FIG. 8. In this regard, the measurement data corresponding to the measurement points 3, 4 and 5 are combined, and it is checked whether or not a combination of the measurement data corresponding to the measurement points 3, 4 and 5 substantially matches the second predefined model ‘B’. In the example herein, let us consider that the aforesaid combination substantially matches the second predefined model ‘B’. Thus, it can be concluded that the assumption of the second predefined model ‘B’ is has a very high probability. In other words, an object having the second predefined model ‘B’ is very likely present at the aforesaid spatial positions.

Likewise, a third predefined model ‘C’ is assumed to be present at three spatial positions corresponding to the measurement points 4, 5 and 6, as shown in FIG. 8. In this regard, the measurement data corresponding to the measurement points 4, 5 and 6 are combined, and it is checked whether or not a combination of the measurement data corresponding to the measurement points 4, 5 and 6 substantially matches the third predefined model ‘C’. In the example herein, let us consider that the aforesaid combination does not substantially match the third predefined model ‘C’. Thus, it can be concluded that the assumption of the third predefined model ‘C’ has a very low probability. In other words, object having the third predefined model ‘C’ is present at the aforesaid spatial positions at a very low probability.

Likewise, a fourth predefined model ‘D’ is assumed to be present at two spatial positions corresponding to the measurement points 6 and 7, as shown in FIG. 8. In this regard, the measurement data corresponding to the measurement points 6 and 7 are combined, and it is checked whether or not a combination of the measurement data corresponding to the measurement points 6 and 7 substantially matches the fourth predefined model ‘D’. In the example herein, let us consider that the aforesaid combination does not substantially match the fourth predefined model ‘D’. Thus, it can be concluded that the assumption of the fourth predefined model ‘D’ has a very low probability. In other words, object having the fourth predefined model ‘D’ is present at the aforesaid spatial positions at a very low probability.

FIG. 8 is merely an example, which should not unduly limit the scope of the claims herein. It is to be noted here that a number of measurement points at which the measurement data can be collected is not limited to any specific number. Moreover, a number of models, namely a number of shapes of interest and their poses and/or sizes, is not limited to any specific number. A person skilled in the art will recognize many variations, alternatives, and modifications of embodiments of the present disclosure.

FIG. 9 is a schematic illustration of a second example of how model matching can be used for object detection, in accordance with an embodiment of the present disclosure.

In FIG. 9, there is shown a route 902 that a measurement device traverses during collection of measurement data.

In the illustrated example, the measurement data is collected at seven different measurement points on the route 902. These measurement points have been marked 1, 2, 3, 4, 5, 6 and 7 in FIG. 9.

With reference to FIG. 9, a predefined model, namely a square, is selected to perform the model matching.

A square ‘E’ is assumed to be present at three spatial positions corresponding to the measurement points 1, 2 and 3, as shown in FIG. 9. In the illustrated example, let us consider that based on a match between the square ‘E’ and a combination of the measurement data corresponding to the measurement points 1, 2 and 3, a probability of a presence of the square ‘E’ is determined to be 0.1.

Likewise, a square ‘F’ is assumed to be present at three spatial positions corresponding to the measurement points 3, 4 and 5, as shown in FIG. 9. In the illustrated example, let us consider that based on a match between the the square ‘F’ and a combination of the measurement data corresponding to the measurement points 3, 4 and 5, a probability of a presence of the square ‘F’ is determined to be 0.3.

Likewise, a square ‘G’ is assumed to be present at three spatial positions corresponding to the measurement points 5, 6 and 7, as shown in FIG. 9. In the illustrated example, let us consider that based on a match between the the square ‘G’ and a combination of the measurement data corresponding to the measurement points 5, 6 and 7, a probability of a presence of the square ‘G’ is determined to be 0.1.

As the probability of the presence of the square ‘F’ is higher than the probabilities of the presence of the squares ‘E’ and ‘G’, it can be concluded that the square ‘F’ is present at the spatial positions corresponding to the measurement points 3, 4 and 5.

FIG. 9 is merely an example, which should not unduly limit the scope of the claims herein. It is to be noted here that a number of measurement points at which the measurement data can be collected is not limited to any specific number. A person skilled in the art will recognize many variations, alternatives, and modifications of embodiments of the present disclosure.

It is to be noted here that although the implementation of the measurement device has been illustrated with reference to a situation where the measurement device is moving, the measurement device can be used in situations where the measurement device is static and objects to be detected are moving or static in a similar manner. In such situations, measurement data can be collected from different spatial positions either by changing a direction of emission of light beams, or by emitting multiple light beams to different directions simultaneously from the measurement device, so as to cover different spatial positions in surroundings of the measurement device.

Embodiments of the present disclosure are susceptible to being used for various purposes, including, though not limited to, enabling detection of objects for measurements comprising a substantial amount of noise.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of detecting objects, the method comprising:
collecting measurement data from a plurality of different spatial positions;
matching at least one predefined model with the measurement data over the plurality of different spatial positions; and
detecting at least one object present at the plurality of different spatial positions, based on the matching.

2. The method of claim 1, wherein the measurement data comprises a substantial amount of noise.

3. The method of claim 2, wherein the matching comprises combining the measurement data for pluralities of spatial positions.

4. The method of claim 3, wherein the detecting comprises detecting an object in a given plurality of spatial positions when a combination of the measurement data for the given plurality of spatial positions substantially matches at least one model defined for the object

5. The method of claim 1, wherein the at least one predefined model is selected from a group consisting of a planar surface, a polygon, a line, a curve, a catenary, a triangle, a rectangle, and a spline surface.

6. An apparatus for detecting objects, the apparatus comprising:
a light source;
a light detector; and
a processor communicably coupled to the light source and the light detector, wherein the processor is configured to:
control the light source and the light detector to collect measurement data from a plurality of different spatial positions;
match at least one predefined model with the measurement data over the plurality of different spatial positions; and
detect at least one object present at the plurality of different spatial positions, based on the match.

7. The apparatus of claim 6, wherein the measurement data comprises a substantial amount of noise.

8. The apparatus of claim 7, wherein the processor is configured to combine the measurement data for pluralities of spatial positions during the matching.

9. The apparatus of claim 8, wherein the processor is configured to detect an object in a given plurality of spatial positions when a combination of the measurement data for the given plurality of spatial positions substantially matches at least one model defined for the object.

10. The apparatus of claim 6, wherein the at least one predefined model is selected from a group consisting of a planar surface, a polygon, a line, a curve, a catenary, a triangle, a rectangle, and a spline surface.

11. The apparatus of claim 6, wherein the apparatus is implemented by way of an airborne measurement device.

12. The apparatus of claim 6, wherein the apparatus is implemented as a part of a vehicle navigation and safety system.

13. A system for detecting objects, the system comprising:
at least one measurement device comprising:
a light source;
a light detector; and
a processor communicably coupled to the light source and the light detector, the processor being configured to control the light source and the light detector to collect measurement data from a plurality of different spatial positions; and
a data processing arrangement communicably coupled to the at least one measurement device, wherein the data processing arrangement is configured to:
collect the measurement data from the at least one measurement device;
match at least one predefined model with the measurement data over the plurality of different spatial positions; and
detect at least one object present at the plurality of different spatial positions, based on the match.

14. The system of claim 13, wherein the measurement data comprises a substantial amount of noise.

15. The system of claim 14, wherein the data processing arrangement is configured to combine the measurement data for pluralities of spatial positions during the matching.

16. The system of claim 15, wherein the data processing arrangement is configured to detect an object in a given plurality of spatial positions when a combination of the measurement data for the given plurality of spatial positions substantially matches at least one model defined for the object.

17. The system of claim 13, wherein the at least one predefined model is selected from a group consisting of a planar surface, a polygon, a line, a curve, a catenary, a triangle, a rectangle, and a spline surface.

18. The system of claim 13, wherein the at least one measurement device is implemented by way of an airborne measurement device.

19. The system of claim 13, wherein the system is implemented as a part of a vehicle navigation and safety system.

20. A computer program product comprising a non-transitory machine-readable data storage medium having stored thereon program instructions that, when accessed by a processing device, cause the processing device to:
collect measurement data from a plurality of different spatial positions;
match at least one predefined model with the measurement data over the plurality of different spatial positions; and
detect at least one object present at the plurality of different spatial positions, based on the match.
